(19) United States
(12) Patent Application Publication
(10) Pub. No.: US 2008/0227061 A1
(43) Pub. Date: Sep. 18, 2008

(54) Automatic Revolution Apparatus of a Globe and Lelestial Globe

(76) Inventor: Dong-Bong Kim, Gyeongsangnam-do (KR)

Correspondence Address: SUGHRUE MION, PLLC, 2100 PENNSYLVANIA AVENUE, N.W., SUITE 800, WASHINGTON, DC, 20037, US

(21) Appl. No.: 12/064,254

(22) PCT Filed: Aug. 19, 2006
(86) PCT No.: PCT/KR06/03266

§ 371 Date: Feb. 20, 2008

(30) Foreign Application Priority Data
Aug. 22, 2005 (KR) 10-2005-0076589

(51) Int. Cl. G09B 27/06

(52) U.S. Cl. 434/136

(57) ABSTRACT

An automatic revolution apparatus is disclosed. An automatic revolution apparatus comprises a celestial globe of trans-=parent material fixedly installed on an upper surface of a revolution plate rotated by a revolution shaft; a globe of transparent material provided within the celestial globe and rotated by a rotation shaft installed at the angle of 66.5° with respect to the horizontal direction, with the standard map of the world displayed thereon; a revolution device installed within an upper and lower cover to rotate the revolution shaft; a rotation device installed within the revolution plate to rotate the rotation shaft; a celestial globe view horizon provided within the celestial globe to be the horizon of an observer; a zenith display part vertically provided in a center of the celestial globe view horizon to display the observer's position; and a manual operation knob installed at an end of the rotation shaft for a user to rotate the globe manually. An object of the present invention devised to solve the problem is to provide an automatic revolution apparatus of a globe and celestial globe which can present the earth position, seen from the sun and other stars, and can enhance students scientific thinking power to comprehend the revolution of the universe spatially and three-dimensionally.

### TECHNICAL FIELD

The present invention relates to an automatic revolution apparatus of a globe and a celestial globe, and more particularly, to an automatic revolution apparatus of a globe and celestial globe which can present the earth position, seen from the sun and other stars, and can enhance students scientific thinking power to comprehend the revolution of the universe spatially and three-dimensionally.

### BACKGROUND ART

Generally, when the revolution of the earth is studied in a class of an elementary and high school, it is very difficult to make students understand the revolution of the earth with a globe, a celestial globe, and the like spatially and three-dimensionally.

Many parents keep a globe on their children's educational purpose in their houses and the research reads that approximate 1,500,000 globes are consumed a year in Korea alone. Nevertheless, students only understand the meaning of the ‘rotation of the earth’ and ‘the revolution of the earth’ but rarely explain the position of the sun at the present time in a spatial view even though they have learned the rotation direction of the earth or the revolution of the earth from their elementary school.

Thus, many kinds of celestial gloves and globes have been suggested to efficiently make students understand the rotation/revolution of the earth, change of night and day, the change of seasons, the passage of the sun and revolution of the stars.

Korean Patent Publication No. 10-2002-0096019 discloses a globe apparatus for performing rotation/revolution, which has a globe and a revolution unit. According to the globe apparatus for performing rotation/revolution comprises a base, a supporting arm, a globe and a revolution unit. The base fixes an end of at least one supporting rod thereto and rotatably fixes an end of a revolution shaft thereto. The supporting arm is fastened to the supporting rod. Two opposite portions of the globe are rotatably fastened to the supporting arm to be inclined at a predetermined angle. The revolution unit is provided within the globe and fastened to a revolution shaft to revolute round the two portions of the globe. Also, the revolution unit divides the night and the day according to the rotation of the globe.

### DISCLOSURE OF INVENTION

### Technical Problem

In the prior art, a light is used to divide the night and the day, and the revolution is explained by changing the angle of the light. The system of the prior art cannot explain the principle of the revolution scientifically.

Thus, the structure of the device is complex. Also, the height of the sun, variable according to each season and each time period, cannot be comprehended mathematically, and the time for the sunset and sunrise cannot be told precisely.

Furthermore, the position of the sun on the passage of the sun at the present time and the position of the star observable from a horizontal view at the present time cannot be presented precisely and perfectly.

Still further, variable situations according to the change of the seasons cannot be presented in numbers.

Therefore, there are a lot of problems to use the conventional revolution devices as the text in schools.

An object of the present invention devised to solve the problem is to provide an automatic revolution apparatus of a globe and celestial globe which can present the earth position, seen from the sun and other stars, and can enhance students scientific thinking power to comprehend the revolution of the universe spatially and three-dimensionally.

### Technical Solution

To achieve these objects and other advantages and in accordance with the purpose of the invention, as embodied and broadly described herein, an automatic revolution apparatus comprises a celestial globe of transparent material fixedly installed on an upper surface of a revolution plate rotated by a revolution shaft; a globe of transparent material provided within the celestial globe and rotated by a rotation shaft installed at the angle of 66.5° with respect to the horizontal direction, with the standard map of the world displayed thereon; a revolution device installed within an upper and lower cover to rotate the revolution shaft; a rotation device installed within the revolution plate to rotate the rotation shaft; a celestial globe view horizon provided within the celestial globe to be the horizon of an observer; a zenith display part vertically provided in a center of the celestial globe view horizon to display the observer's position; and a manual operation knob installed at an end of the rotation shaft for a user to rotate the globe manually.

Here, the revolution device comprises a revolution movement installed in a height adjusting part provided on a down surface of the lower cover to operate one rotation of a revolution-hour-hand-gear every 12 hour; an expansion gear installed in the revolution-hour-hand-gear with screws 10 times as many as screws of the revolution-hour-hand-gear and having a warm gear formed in a center thereof; and a revolution gear rotated 730 times as slowly as the revolution-hour-hand-gear in communication with the warm gear to operate one rotation of the revolution shaft at 365 day-period in a clockwise direction.

The rotation device comprises a rotation movement installed in a supporting part fixed within the revolution plate to operate one rotation of a rotation-hour-hand-gear every 11 hour 58 minute; and a an expansion gear installed in the rotation our hand gear to operate the rotation shaft every 23 hour 56 minute, which is the real time for the rotation of the earth, in a counter-clockwise direction with gears twice as many as gears of the rotation-hour-hand-gear.

Preferably, a supporting part is fixed in the revolution movement and has a hinge part fastened to the height adjusting part, and a handle is provided in the supporting part for a user to operate the celestial globe manually after the hinge part separates the revolution movement from the revolution gear.

Furthermore, a passage of the sun and a date display part for displaying each date and month corresponding to each passage of the sum are formed on a surface of the celestial globe.

The globe is installed at the angle of 66.5° with respect to the horizontal surface, which is the same as the rotation shaft, and the center of the globe is on the line extended from the revolution shaft and the polar star of the glove is on the same line of the rotation shaft and the center of the celestial glove is positioned at the portion where the revolution shaft meets the rotation shaft.

### ADVANTAGEOUS EFFECTS

An automatic revolution apparatus of a glove and celestial glove according to present invention has an advantageous effect that the time of the sunrise/sunset in every country can be seen exactly as well as that the height of the sun every season and every time can be mathematically comprehended without any difficulties, because the position of the earth seen from the sun and stars is presented perfectly.

Furthermore, the automatic revolution apparatus of a glove and celestial glove according to present invention has another advantageous effect that students can three-dimensionally understand the motion of the universe, because the position of the sun on the present passage of the sun and the position of the stars can be presented perfectly.

Still further, the automatic revolution apparatus of a glove and celestial glove according to present invention has a third advantageous effect that students can improve their thinking power, because they can see the rotation/revolution of the earth and diurnal/annual motion of the stars with their own eyes.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a perspective view illustrating an automatic revolution apparatus of a globe and a celestial globe according to the present invention;

FIG. 2 is an exploded perspective view illustrating the automatic revolution apparatus of a globe and a celestial globe according to the present invention;

FIG. 3 is a front sectional view illustrating the automatic revolution apparatus of a globe and a celestial globe according to the present invention;

FIG. 4 is a sectional view illustrating an A-A line of FIG. 3;

FIG. 5 illustrates the passage of the sun and the date carved on the celestial glove;

FIG. 6 is a diagram illustrating a state where a revolution movement and a revolution shaft are separated in the automatic revolution apparatus of a globe and a celestial globe according to the present invention;

FIG. 7 is a perspective view illustrating an operation state of a rotation device according to the automatic revolution apparatus of a globe and a celestial glove;

FIG. 8 is a perspective view illustrating an operation state of a revolution device according to the automatic revolution apparatus of a globe and a celestial globe;

FIG. 9 is a diagram illustrating the passage of the sun and the annul motion of the stars; and

FIG. 10 is a diagram illustrating the diurnal motion and the annul motion due to the rotation and revolution of the earth according to the automatic revolution apparatus of a globe and a celestial globe.

### BEST MODE FOR CARRYING OUT THE INVENTION

Reference will now be made in detail to the preferred embodiments of the present invention, examples of which are illustrated in the accompanying drawings.

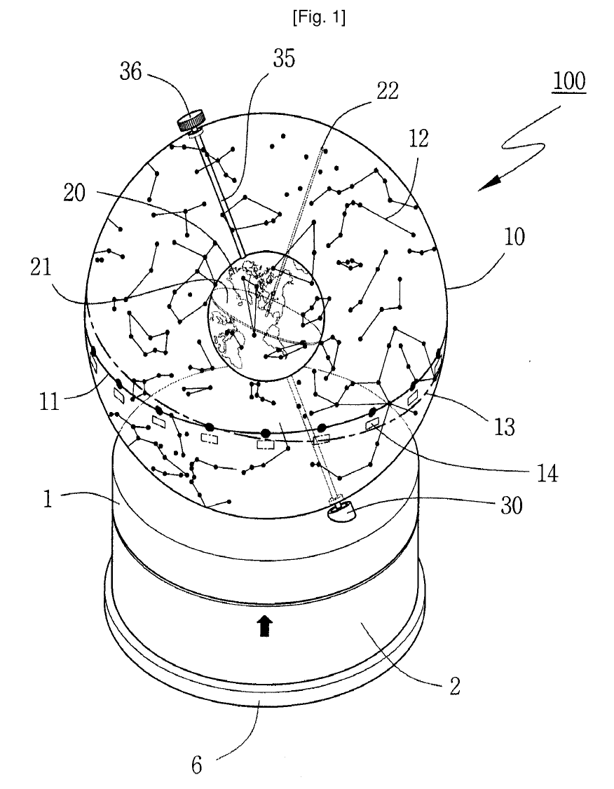

Referring to FIGS. 1 to 10, an automatic revolution apparatus of a glove and a celestial globe 100 according to the present invention will be described.

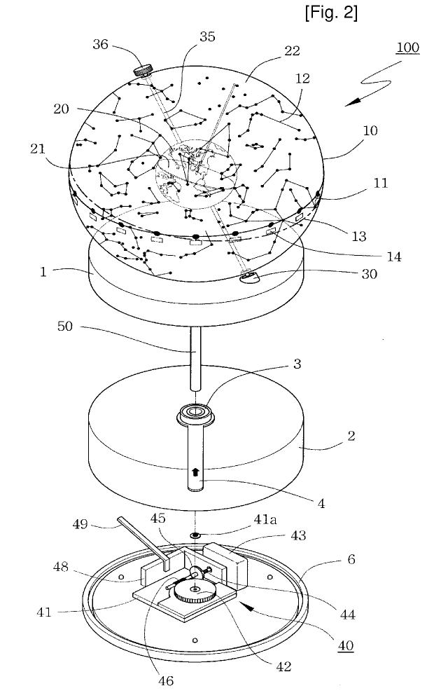

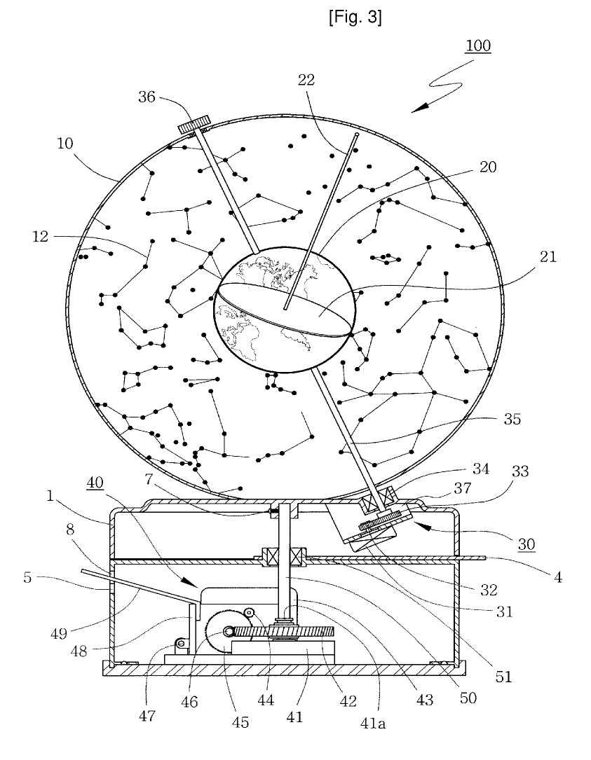

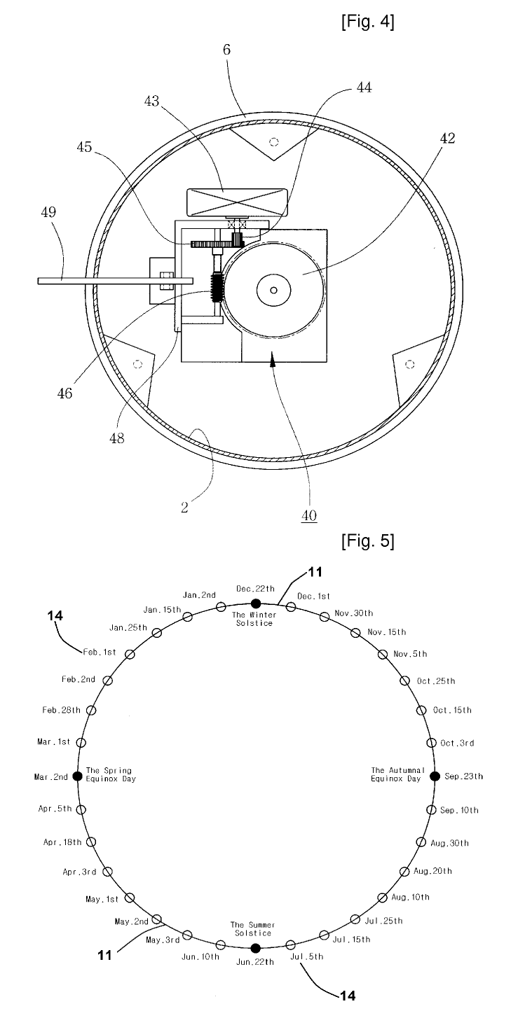

FIG. 1 is a perspective view illustrating an automatic revolution apparatus of a globe and a celestial globe according to the present invention, FIG. 2 is an exploded perspective view illustrating the automatic revolution apparatus of a globe and a celestial globe according to the present invention, FIG. 3 is a front sectional view illustrating the automatic revolution apparatus of a globe and a celestial globe according to the present invention, and FIG. 4 is a sectional view illustrating an A-A line of FIG. 3.

The automatic revolution apparatus of a globe and a celestial globe 100 comprises a celestial globe 10, a globe 20, a revolution plate 1, a rotation device 30 and a revolution device 40. The celestial globe 10 is made of transparent material, and the passage of the sun 13 and numerous stars 12 are displayed on the celestial globe 10. The globe 20 also made of transparent material is provided in a center of celestial globe 10 and the standard map of the world is displayed on the globe 20. The revolution plate 1 rotates the celestial globe 10. The revolution device 40 operates one rotation of the revolution plate 1 every year in a clockwise direction. The rotation device 30 operates one rotation of the globe 20 every 23 hour 56 minute, which is the actual time for the rotation of the earth, in a counter-clockwise direction.

The celestial globe 10 is inclinedly fixed to the upper horizontal surface of the revolution plate 1 and a revolution shaft 50 is downwardly installed in an inner surface center of the revolution plate 1 by a bolt 7. Also, the rotation device 30 is installed within the revolution plate 1.

The revolution device 40 has a revolution movement 43, an expansion gear 45 and a revolution gear 42. The revolution movement 43 is installed on a height adjusting part 41 provided on an upper surface of the lower cover 6 to operate one rotation of a revolution-hour-hand-gear 44 every 12 hour. The expansion gear 45 is in communication with the revolution-hour-hand-gear 44 with screws 10 times as many as screws of the revolution hand gear 44 and has a warm gear 46 formed in a center thereof. The revolution gear 42 is installed in a side of the warm gear 46 and has 73 screw threads to move one of the 73 screw threads when the warm gear 46 is rotated once. Hence, the revolution gear 42 is rotated 730 times as slowly as the revolution-hour-hand-gear 44 to operate one rotation of the revolution plate 1 every year in a clockwise direction. A coupling 41a is installed on an upper portion of the revolution gear 42 to communicate the revolution shaft 50 with the revolution gear 42.

Also, a supporting part 48 is fixed on a side portion of the revolution movement 43 and has a hinge part 47 fastened to the height adjusting part 41. A handle 49 is installed on the supporting part 48 to connect/disconnect the warm gear 46 to/from the revolution gear 42, so that the damage of the warm gear 46 is prevented in case the revolution plate 1 is rotated manually.

The revolution device 40 is fastened to an upper portion of the lower cover 6 and a revolution-shaft-inserting-part 3 is projected to insert the revolution shaft 50 therein. A standard setting part 4 is formed in a side of the revolution device 40 to determine an operation standard point of the revolution device 40 and the handle 49 is protected on the other side of the revolution device 40 by the upper cover 2 not to expose the handle 49 outside. The upper cover 2 has a through hole 8 and a step 5 formed thereon. The revolution plate 1 and the upper cover 2 are spaced apart a predetermined distance as far as the height of the revolution-shaft-inserting-part 3 and a bearing 51 is installed in a center of the revolution plate 1 to make the rotation of the revolution plate 1 without any difficulties.

The rotation device 30 includes a rotation movement 31, an expansion gear 33, a rotation shaft 35 and a manual operation knob 36. The rotation movement 31 is installed on a supporting part 37 to operate one rotation of the rotation-hour-hand-gear 32 every 11 hour 58 minute. The expansion gear 33 is installed on a side of the rotation-hour-hand-gear 32 to operate one rotation of a rotation shaft 35 in a counter-clockwise direction every 23 hour 56 minute, which is the actual time for the rotation of the earth, with screws twice as many as the screws of the rotation-hour-hand-gear 32. The rotation shaft 35 is installed in a center of the expansion gear 33 to rotate the globe 20. The manual operation knob 36 is installed at an end of the rotation shaft 35 to rotate the rotation shaft 35 manually.

The rotation shaft 35 is installed at the angle of 66.5° with respect to the horizontal surface and the center of the globe 20 is on the line extended from the revolution shaft 50. The polar star of the celestial globe 10 is on the same line of the rotation shaft 35 and the center of the celestial globe 10 is positioned at the portion where the revolution shaft 50 meets the rotation shaft 35. A celestial globe view horizon 21 is provided in the center of the globe 20 to show the horizon where an observer is positioned and a zenith display part 22 is provided in a center of the celestial glove view horizon 21 to display the observer's position.

Here, the zenith display part 22 passes through Seoul in Korea on convenience sake and it is fixed to observe the celestial globe at Seoul.

A date display part 14 is formed on the celestial globe 10 and displays a plurality of stars 12 and equator lines 13, the passage of the sun 11, every month and date of a year for every passage of the sun, as shown in FIG. 5.

The driving power of the revolution device 40, the rotation device 30, the revolution movement 43 and the rotation movement 31 is a battery. The battery is provided within the revolution plate 1, and the structure is well-known to anyone skilled in the art, thereby the description thereof being omitted.

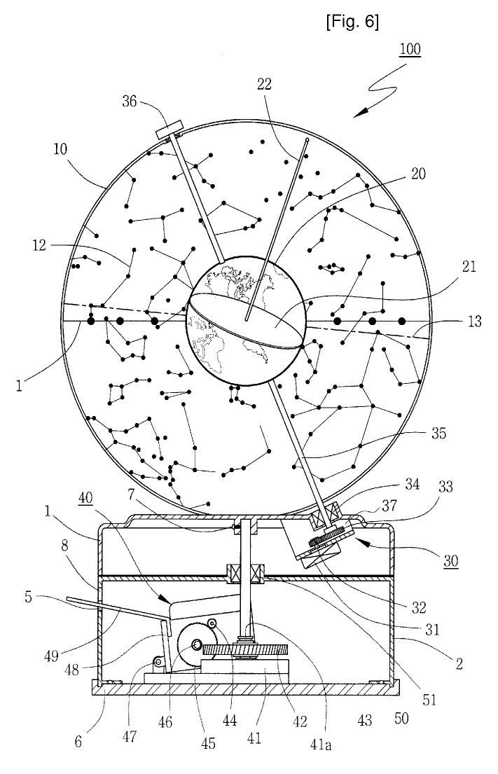

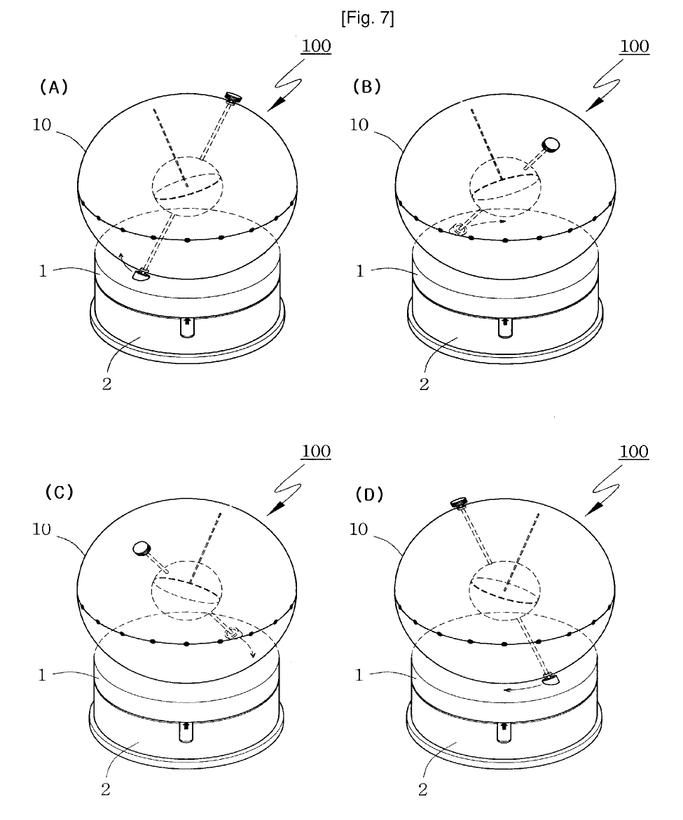

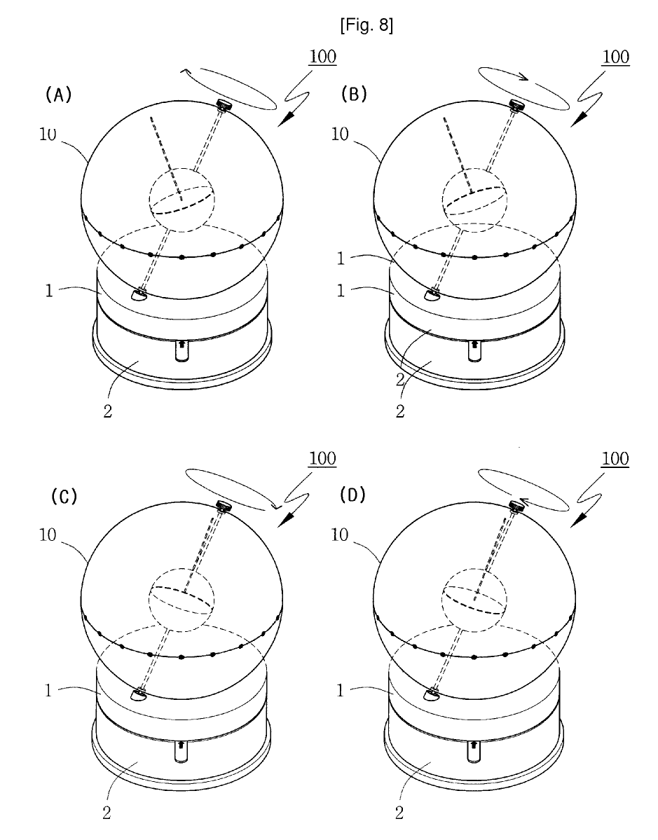

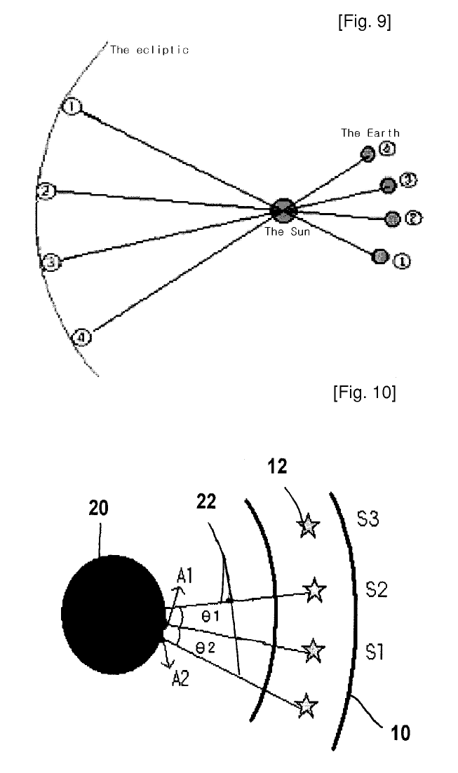

FIG. 5 illustrates the passage of the sun and the date carved on the celestial glove, FIG. 6 is a diagram illustrating a state where a revolution movement and a revolution shaft are separated in the automatic revolution apparatus of a globe and a celestial globe according to the present invention, FIG. 7 is a perspective view illustrating an operation state of a rotation device according to the automatic revolution apparatus of a globe and a celestial glove, FIG. 8 is a perspective view illustrating an operation state of a revolution device according to the automatic revolution apparatus of a globe and a celestial globe, FIG. 9 is a diagram illustrating the passage of the sun and the annul motion of the stars and FIG. 10 is a diagram illustrating the diurnal motion and the annul motion due to the rotation and revolution of the earth according to the automatic revolution apparatus of a globe and a celestial globe.

The assembly process of the present invention will be described as follows.

First of all, the revolution device 40 and the rotation device 30 are installed on the upper surface of the lower cover 6. The revolution device 40 includes the revolution shaft 50 and rotates the revolution shaft 50 once every year in a clockwise direction. The rotation device 30 includes a revolution shaft 50 maintaining the angle of 66.5° with respect to the horizontal floor to rotate the rotation shaft 35 every 23 hour 56 minute in a counter-clockwise direction.

Hence, the globe 20 having the celestial view horizon 21 and the zenith display part 22 is installed to the revolution shaft 50, and then the celestial globe 20 is installed on the upper surface of the revolution plate 1, in a right portion of the globe 20. The celestial globe 10 has the starts 12, the equator lines 13 and the date display part 14 formed thereon. The center of the globe 20 is on the extended line of the revolution shaft 50 and the polar star is on the same line of the rotation shaft 35. The manual operation knob 36 is exposed outside from the end of the rotation shaft 35 and fixed by a screw.

Hence, the upper cover 2 is seated on the lower cover 6 and fastened by a screw to protect the revolution device 40. At that time, the handle 49 of the revolution device 40 is exposed through the through hole 8 formed on the upper cover 2.

As mentioned above, the rotation device 30, the celestial globe 10 and globe 20 are assembled to the revolution plate 1. The revolution shaft 50 is connected to the revolution device 40 through the coupling 41a in communication with the bearing 51 and the revolution gear 42 in a state where the revolution device 40 and the upper cover 2 are fastened to each other.

Next, the operation of the present invention will be described in detail.

First of all, to operate the automatic revolution apparatus of a globe and a celestial globe 100, the celestial globe 10 and the globe 20 are set in a standard setting part 4 according to the present date and time.

That is, when the handle 49 of the revolution device 40 is lifted and seated on a step 5 formed on the upper cover 6, the warm gear 46 is separated from the revolution gear 42 installed on the revolution movement 43 not to communicate each other. Thus, as shown in FIG. 6, the revolution plate 1 installing the revolution shaft 50 thereon may be manually operated.

In that state, the revolution plate 1, installing the celestial globe 10 thereon and connected to the revolution shaft 50, is rotated manually as shown in FIG. 5 so that the revolution plate 1 may be positioned on the same line of the standard setting part 4 formed on the upper cover 2 to make the date displayed on the passage of the sun carved on the celestial globe 10 approximately corresponding to the present date and time. After that, the handle 49 of the revolution device 40 is restituted downwardly to the original position to engage the warm gear 46 to the revolution gear 42. Thus, only the operation of the revolution movement 43 can rotate the revolution plate 1.

Next, the manual knob 36 is adjusted to rotate the globe 20 installed on the rotation shaft 35 so that the zenith display part 22 may be positioned at the height of the sun corresponding to the approximate present time displayed on the celestial globe 20.

That is, once the manual operation knob 36 is rotated, the globe 20 is rotated in communication with the manual operation knob 36. Hence, the zenith display part 22 moves, which is vertically installed in the center of the globe 20, and the position of the zenith display part 22 is adjusted to position of the passage of the sun 12 corresponding to the present time.

Hence, the battery supplies power to the revolution movement 43 of the revolution device 40 and the rotation movement 31 of the rotation device 30 to operate the revolution shaft 50 and the rotation shaft 35.

When the power is supplied to the revolution movement 43 of the revolution device 40, the revolution movement 43 operates one rotation of the revolution-hour-hand-gear 44 every 12 hour. When the revolution-hour-hand-gear 44 is rotated, the warm gear 46 is rotated in communication with the revolution-hour-hand-gear 44 with the pitch number 10 times as much as the pitch number of the revolution-hour-hand-gear 44 and the warm gear 46 is rotated at the same time. Thus, one pitch of the expansion gear 45 engaged to the warm gear 46 with 73 screw threads is rotated in a clockwise direction.

That is, the expansion gear 45 is rotated 730 times as slowly as the revolution-hour-hand-gear 44. Hence, in case two rotations of the revolution-hour-hand-gear 44 are operated every 24 hour, two pitches of the expansion gear 45 are moved, thereby operating one rotation of the revolution shaft 50 at 365 day-period in a clockwise direction.

Accordingly, in case two rotations of the revolution-hour-hand-gear 44 is operated every 24 hour to move two pitches of the expansion gear 45, the revolution shaft 50 engaged to the expansion gear 45 by the coupling 41a is rotated 1° in a clockwise direction. In case the revolution shaft 50 is rotated 1°, the revolution plate 1 fixed to the revolution shaft 50 by the bolt 7 is rotated 1° in a clockwise direction. Thus, the celestial globe 10 inclinedly installed on the upper surface of the revolution plate 1 is rotated 1°.

As a result, the revolution device 40 moves the revolution plate 1 by 1° in case the revolution-hour-hand-gear 44 is rotated twice every 24 hour so that one rotation of the celestial globe 10 is operated at 365 day-period in a clockwise direction.

Also, when the power is supplied to the rotation movement 31 of the rotation device 30, the rotation movement 31 operates one rotation of the rotation-hour-hand-gear 32 every 11 hour 58 minute and one rotation of the expansion gear 33, in communication with the rotation-hour-hand-gear 32 and having the gears twice as many as the rotation-hour-hand-gear 32, is operated every 23 hour 56 minute in a counter-clockwise direction. 23 hour 58 minute is the actual time for the rotation of the earth.

That is, once the expansion gear 33 is rotated once every 23 hour 56 minute in a counter-clockwise direction, that means the rotation shaft 35 installed at the angle of 66.5° with respect to the horizontal surface is rotated once in a counter-clockwise direction. Accordingly, the globe 20 is rotated once every 23 hour 56 minute in a counter-clockwise direction.

As the celestial globe 10 is rotated 1° every 24 hour in a clockwise direction by the revolution device 40 and the globe 20 is rotated once every 23 hour 56 minute by the rotation device 30 in a counter-clockwise direction at the same time, the zenith display part 22 points out the constellation displayed on the celestial globe 10 and the passage of the sun 11, the zenith display part 22 points out, presents the present position of the sun.

(a) to (d) shown in FIG. 7 illustrate a revolution state of the celestial globe 10 by the revolution device 40. (a) is the position of the revolution plate 1 in the spring equinox day, (b) is the position of the revolution plate 1 in the winter solstice day, (c) is the position of the revolution plate 1 in the autumnal equinox day and (d) is the position of the revolution plate 1 in the summer solstice day.

As shown in FIG. 7, the rotation shaft 35 is oblique at the angle of 23.5° to the right at the noon (at 12 hour) of the spring equinox day in (a) and the rotation shaft 35 is oblique at the angle of 23.5° to the left at the noon (at 12 hour) of the winter solstice day in (d) when the globe performs one rotation.

The celestial globe 10 installed on the revolution plate 1 performs one revolution at 365-day period and the constellation the zenith display part 22 points out is the present star sign.

(a) to (d) of FIG. 8 shows the rotation state of the globe 20 by the rotation device 30 according to the present invention, as embodying the change of the position the zenith display part 22 points out.

That is, if it is assumed that (a) of FIG. 8 is the position of the zenith display part 22 at the present time of midnight (at 24 hour), the globe 20 is rotated 90° in a counter-clockwise direction by the rotation device 30 and the zenith display part 22 is also moved in a counter-clockwise direction after 6 hours, as shown in (b).

(c) of FIG. 8 shows that the globe 20 is rotated another 90° in a counter-clockwise direction by the rotation device 3 after another 6 hours (at 12 hour) from the time of (b) and the zenith display part 22 also is moved in a counter-clockwise direction. (d) of FIG. 8 shows that the globe 20 is rotated another 90° from the position of (c) after another 6 hours (at 18 hour) from the time of (c) and the zenith display part 22 also is moved in a counter-clockwise direction from the position of the (c). Thus, after another 6 hours from the position of (d), the globe 20 is rotated another 90° from the position of (d) by the rotation device 30 in a counter-clockwise direction after another 6 hours from the time of (d), for the zenith display part 22 to reach the position of (a) again.

As mentioned above, the globe 20 installed in the rotation shaft 35 performs one rotation every 23 hour 56 minute, which is the actual time for the rotation of the earth, so that the point of the globe 20, the zenith display part 22 points out, is changed to change the constellation and the position of the sun, the zenith display part 22 points out.

Next, the operation of the automatic revolution apparatus of a globe and a celestial globe according to the present invention will be described.

FIG. 9 is a diagram illustrating the passage of the sun and the annul motion of the stars. As shown in FIG. 9, the earth is rotated in the state where the earth is revolutionary approximately 1° every day from the east to the west (\textcircled{1}→\textcircled{4}). Thus, there are the diurnal motion and annual motion of the stars which performs one revolution with respect to the polar star.

FIG. 10 is a diagram illustrating the diurnal motion and the annul motion of the stars due to the rotation and revolution of the earth according to the automatic revolution apparatus of a globe and a celestial globe. Since the celestial globe 10 is fixed, the zenith display part 22 culminates with the sun S1 on the passage of the sun at the present time. The zenith display part 22 culminates with the sun S2 after 23 hour 56 minute of the rotation device 30 and a star S2 turns up. also, since the star S2 is southing 24 hours after the rotation of the globe 20 at the revolution angle (θ1), it shows the annul motion of the stars is performed approximately 1° every day from the east to the west (S1→S2→S3).

Thus, when the sun S1 on the present passage of the sun is positioned on the standard setting part 4 formed on the upper cover 2, the revolution plate 1 is rotated approximately 1° every day from the west to the east (S3→S2→S1). Also, since the globe 20 is rotated once every 23 hour 56 minute, S1 is seen from P1 and S2 is seen from the standard setting part 4 after 24 hours. Thus, the position of the sun on the passage of the sun and the globe 20 may be positioned at the standard setting part 4 every 24 hour.

Thereby, the celestial globe 10 is revolutionary 1° in a clockwise direction every 24 hour and the globe 20 performs one rotation every 23 hour 56 minute in a counter-clockwise direction.

If it is assumed that the sun and stars are in the ultimate distance away, the zenith display part 22 provided on the celestial view horizon 21 is the observer's position and then the same situation at the observer's actual horizon is happening. Accordingly, the observer can feel the length change of the day/night and the height change of each season according to the position change of the sun, and also is shown exactly without any errors the direction of the sun/stars and the motion of the universe.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The automatic revolution apparatus of a glove and celestial glove according to present invention has an industrial applicability that the time of the sunrise/sunset in every country can be seen exactly as well as that the height of the sun every season and every time can be mathematically comprehended without any difficulties, because the position of the earth seen from the sun and stars is presented perfectly.

Furthermore, the automatic revolution apparatus of a glove and celestial glove according to present invention has another industrial applicability that students can three-dimensionally understand the motion of the universe, because the position of the sun on the present passage of the sun and the position of the stars can be presented perfectly.

Still further, the automatic revolution apparatus of a glove and celestial glove according to present invention has a third industrial applicability that students can improve their thinking power, because they can see the rotation/revolution of the earth and diurnal/annual motion of the stars with their own eyes.

1. An automatic revolution apparatus comprising:
a celestial globe of transparent material fixedly installed on an upper surface of a revolution plate rotated by a revolution shaft;
a globe of transparent material provided within the celestial globe and rotated by a rotation shaft installed at the angle of 66.5° with respect to the horizontal direction, with the standard map of the world displayed thereon;
a revolution device installed within an upper and lower cover to rotate the revolution shaft;
a rotation device installed within the revolution plate to rotate the rotation shaft;
a celestial globe view horizon provided within the celestial globe to be the horizon of an observer;
a zenith display part vertically provided in a center of the celestial globe view horizon to display the observer's position; and
a manual operation knob installed at an end of the rotation shaft for a user to rotate the globe manually,
wherein the revolution device comprises:
a revolution movement installed in a height adjusting part provided on a down surface of the lower cover to operate one rotation of a revolution-hour-hand-gear every 12 hour;
an expansion gear installed in the revolution-hour-hand-gear with screws 10 times as many as screws of the revolution-hour-hand-gear and having a warm gear formed in a center thereof; and
a revolution gear rotated 730 times as slowly as the revolution-hour-hand-gear in communication with the warm gear to operate one rotation of the revolution shaft at 365 day-period in a clockwise direction, and
the rotation device comprises:
a rotation movement installed in a supporting part fixed within the revolution plate to operate one rotation of a rotation-hour-hand-gear every 11 hour 58 minute; and
a an expansion gear installed in the rotation our hand gear to operate the rotation shaft every 23 hour 56 minute, which is the real time for the rotation of the earth, in a counter-clockwise direction with gears twice as many as gears of the rotation-hour-hand-gear.

2. The automatic revolution apparatus as claimed in claim 1, wherein a supporting part is fixed in the revolution movement and has a hinge part fastened to the height adjusting part, and a handle is provided in the supporting part for a user to operate the celestial globe manually after the hinge part separates the revolution movement from the revolution gear.

3. The automatic revolution apparatus as claimed in claim 1, wherein a passage of the sun and a date display part for displaying each date and month corresponding to each passage of the sum are formed on a surface of the celestial globe.

4. The automatic revolution apparatus as claimed in claim 1, wherein the globe is installed at the angle of 66.5° with respect to the horizontal surface, which is the same as the rotation shaft, and the center of the globe is on the line extended from the revolution shaft and the polar star of the glove is on the same line of the rotation shaft and the center of the celestial glove is positioned at the portion where the revolution shaft meets the rotation shaft.
